(19) United States
(12) Patent Application Publication
(10) Pub. No.: US 2009/0297785 A1
(43) Pub. Date: Dec. 3, 2009

(54) ELECTRONIC DEVICE AND METHOD OF MANUFACTURING THE SAME

(75) Inventors: Satoshi UEDA, Kawasaki (JP); Xiaoyu MI, Kawasaki (JP); Takeo TAKAHASHI, Yokohama (JP)

Correspondence Address: ARENT FOX LLP, 1050 CONNECTICUT AVENUE, N.W., SUITE 400, WASHINGTON, DC, 20036, US

(73) Assignees: FUJITSU MEDIA DEVICES LIMITED, kanagawa (JP); FUJITSU LIMITED, Kanagawa (JP)

(21) Appl. No.: 12/474,919

(22) Filed: May 29, 2009

(30) Foreign Application Priority Data
Jun. 2, 2008 (JP) 2008-144812

(51) Int. Cl. B32B 3/00; C04B 33/32; H01G 13/00

(52) U.S. Cl. 428/172; 156/89.12

(57) ABSTRACT

There is provided a method for manufacturing an electronic device including: printing a conductive pattern on a first surface of a first green sheet having a multilayer structure, the conductive pattern being electrically connected to an internal interconnection formed in the first green sheet; superposing a second green sheet on the first surface of the first green sheet, the second green sheet having an opening located in an area corresponding to the conductive pattern; pressurizing the first green sheet and the second green sheet superposed thereon in directions in which the second green sheet is superposed on the first green sheet; burning the first green sheet and the second green sheet superimposed thereon to thus form a multilayer ceramic substrate; and mounting an electronic element on a second surface of the multilayer ceramic substrate opposite to the first surface, the electronic element being electrically connected to the internal interconnection.

### CROSS-REFERENCE TO RELATED APPLICATION

This application is based upon and claims the benefit of priority of the prior Japanese Patent Application No. 2008-144812, filed on Jun. 2, 2008, the entire contents of which are incorporated herein by reference.

### FIELD

A certain aspect of embodiments discussed herein is related to an electronic device using a multilayer ceramic substrate and a method of manufacturing the same.

### BACKGROUND

In the fields of mobile radio communication devices such as portable phones, communication systems and communication frequency bands have become complicated and applications used therein have been increasing and diversifying. RF (Radio Frequency) modules and devices used in the mobile radio communication devices are preferably downsized and height-reduced in terms of limitations on parts mounting.

The modules may be downsized by employing an IPD (Integrated Passive Device) in which passive parts such as inductors and capacitors are integrated. It is also proposed to realize further downsizing in which an IPD using thin films is formed on a surface of a package substrate of multilayer ceramics, and functional elements (chips) and passive elements (chips) are mounted on the IPD.

There is a proposal in which an IC chip has a ceramic substrate on which an insulator layer is formed and a passive device is formed on the insulator layer (see Japanese Laid-Open Patent Application No. 10-98158). There is another proposal in which multiple package forming sections are defined on a surface of a ceramic sheet and cavities for mounting functional elements are formed in the package forming sections (see Japanese Patent Nos. 3427031 and 3404375).

The module using the multilayer ceramic substrate may have an arrangement in which conductive patterns, which may be typically electrode pads for making external connections, are formed by printing on a surface of the ceramic substrate opposite to the surface on which the IPD is formed. The conductive patterns have a predetermined thickness, and may considerably protrude from the flat surface of the ceramic substrate. This results in a roughness on the surface of the ceramic substrate. The roughness on the surface of the ceramic substrate may reduce the thermal conductivity in the heating and cooling steps and may degrade the stability in holding the ceramic substrate by a wafer chuck. This may lower the production yield.

### SUMMARY

According to an aspect of the present invention, there is provided a method for manufacturing an electronic device including: printing a conductive pattern on a first surface of a first green sheet having a multilayer structure, the conductive pattern being electrically connected to an internal interconnection formed in the first green sheet; superposing a second green sheet on the first surface of the first green sheet, the second green sheet having an opening located in an area corresponding to the conductive pattern; pressurizing the first green sheet and the second green sheet superposed thereon in directions in which the second green sheet is superposed on the first green sheet; burning the first green sheet and the second green sheet superimposed thereon to thus form a multilayer ceramic substrate; and mounting an electronic element on a second surface of the multilayer ceramic substrate opposite to the first surface, the electronic element being electrically connected to the internal interconnection.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a plan view of a wafer from which electronic devices are manufactured;

FIG. 2 is a cross-sectional view of an electronic device related to an aspect of embodiments described hereinafter;

FIGS. 3A through 3F are cross-sectional views of a wafer illustrating a method for manufacturing an electronic device in accordance with a first embodiment;

FIGS. 4A through 4D are cross-sectional views of the wafer illustrating steps that follow the steps illustrated in FIGS. 3A through 3F;

FIGS. 5A through 5D are cross-sectional views of the wafer illustrating steps that follow the steps illustrated in FIGS. 4A through 4D;

FIG. 6 is a cross-sectional view of the electronic device in accordance with the first embodiment;

FIG. 7A is a perspective view of a wafer from which an electronic device in accordance with a second embodiment is manufactured, and FIG. 7B is a perspective view of a backside of the wafer illustrated in FIG. 7A; and

FIG. 8A is a cross-sectional view of the electronic device in accordance with the second embodiment, and FIG. 8B is an enlarged view of a portion C illustrated in FIG. 8A.

### DESCRIPTION OF EMBODIMENTS

Now, an art related to an aspect of embodiments will be described.

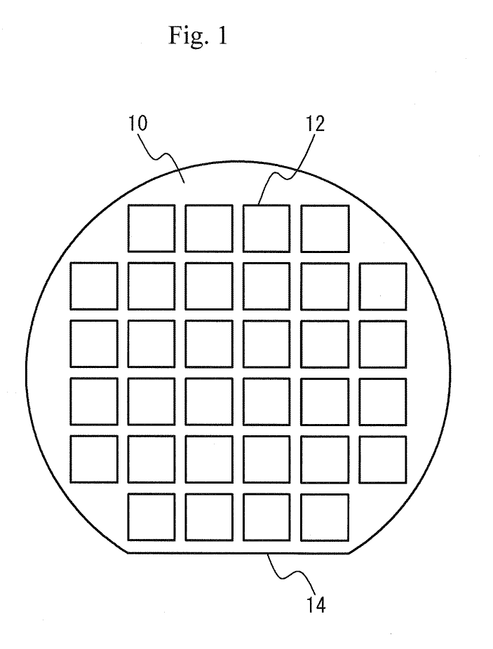

FIG. 1 is a plan view of a multilayer ceramic substrate formed into a wafer. Parts forming sections 12 for forming RF modules that are exemplary electronic devices are regularly defined on a main surface of the dielectric wafer 10. An orientation flat 14 is formed in the dielectric wafer 10 so as to run in a predetermined direction.

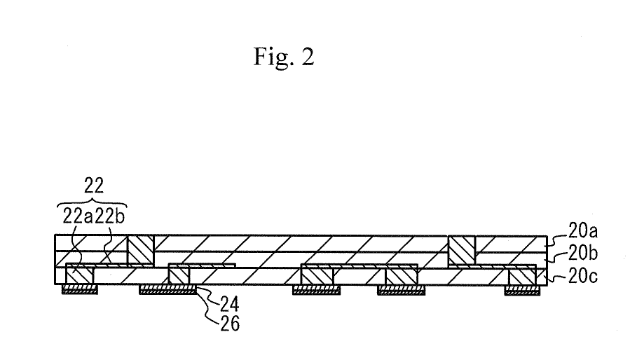

FIG. 2 is a cross-sectional view of a related multilayer ceramic substrate. A multilayer ceramic substrate 20 in FIG. 2 has ceramic substrates 20a through 20c stacked vertically. Each of the ceramic substrates 20a through 20c has a through hole in which a through via is formed. An interlayer interconnection 22b is formed at interfaces defined by the adjacent ceramic substrates. An internal interconnection 22b is defined by the through interconnection 22a and the interlayer interconnection 22b. The upper and lower surfaces of the multilayer ceramic substrate 20 may be electrically connected by the internal interconnections 22.

The upper surface of the multilayer ceramic substrate 20 has a region in which various electronic elements such as passive elements and functional elements may be provided. The electronic elements may be formed directly on the surface of the multilayer ceramic substrate 20 or may be mounted, by soldering, to electrode pads formed on the substrate surface and used for mounting. The electrode elements thus formed or mounted are electrically connected to the internal interconnections 22.

Conductive patterns 24 electrically connected to the corresponding internal interconnection 22 are formed on the lower surface of the multilayer ceramic substrate 20. The conductive patterns 24 may include electrode pads for mounting an electronic device manufactured with the multilayer ceramic substrate 20. The conductive patterns 24 may be 10-50 μm thick and may be thinned to a thickness of 5-30 μm by burning. A protection film 26 is provided on the surfaces of the conductive patterns 24 in order to prevent migration. The protection film 26 may be a laminate of Ni/Pd/Au or Ni/Au in which the lowermost layer is Ni, or may be Cu. The protection film 26 may, for example, be 2-5 μm thick in total.

The conductive patterns 24 and the protection films 26 have a predetermined thickness (for example, 20 μm), which forms a roughness on the lower surface of the multilayer ceramic substrate 20. This roughness may prevent efficient heating and cooling and may cause a deviation between the target temperature and the actual temperature. For example, in the process of forming a passive element on the upper surface of the multilayer ceramic substrate 20, a problem may occur in removal of a seed layer used in plating by ion milling. If the heat radiation efficiency is not good, the multilayer ceramic substrate 20 may be overheated and resist may be changed in property and hardened. This makes it impossible to remove the resist later. Further, the roughness on the lower surface of the multilayer ceramic substrate 20 may make it difficult to stably hold the substrate by a wafer chuck when the resist is exposed and to smoothly transport the wafer. Thus, the production yield may be degraded.

Preferably, the surface of the multilayer ceramic substrate 20 on which the conductive patterns 24 are formed (opposite to the surface on which the passive elements and functional elements are mounted) has a predetermined flatness. The degree of flatness that does not affect the manufacturing process may be such that the roughness is approximately 5 μm or less with respect to the flat surface of the multilayer ceramic substrate 20. An embodiment of the present invention described below is to provide an electronic device using a multilayer ceramic substrate having an improved flatness of the surface on the multilayer ceramic substrate on which conductive patterns are formed and an improved production yield and to provide a method of manufacturing the electronic device.

### First Embodiment

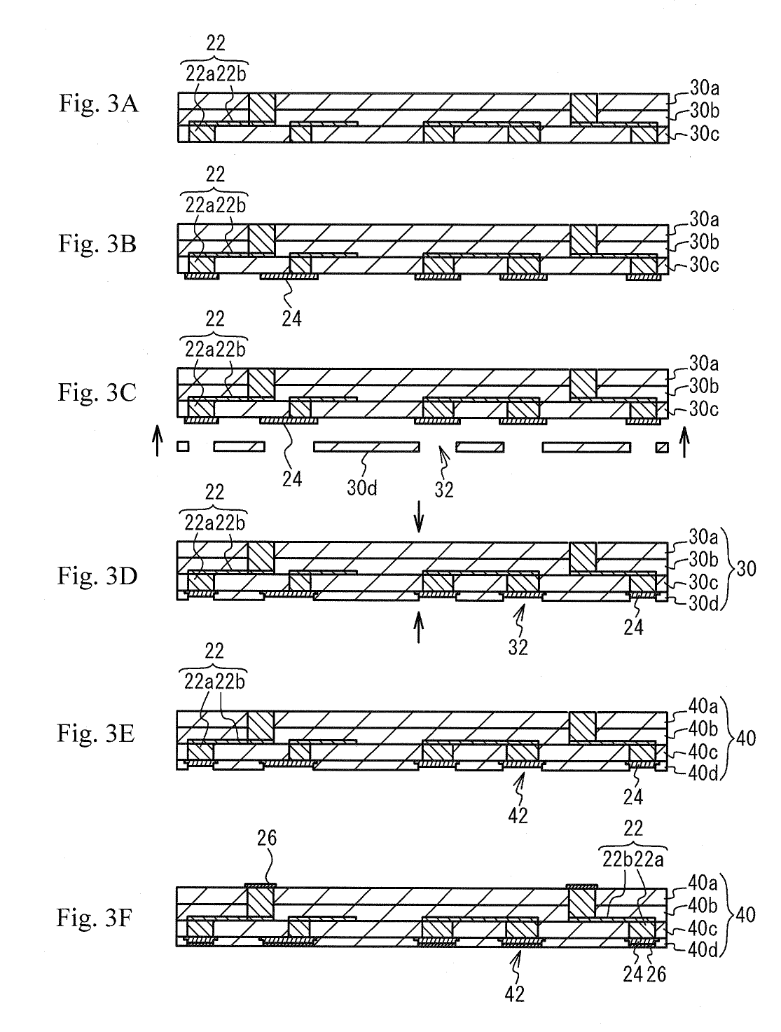

A description will now be given, with reference to FIGS. 3A through 3F, of a method of producing a wafer (multilayer ceramic substrate) used for manufacturing an electronic device in accordance with a first embodiment. FIG. 3A is a cross-sectional view of green sheets stacked. As illustrated, green sheets 30a through 30c are stacked in the vertical direction to form a first green sheet having a multilayer structure. The first green sheet may be referred to as a multilayered green sheet. The green sheets 30a through 30c may be made of a metal oxide, which may, for example, be alumina (Al₂O₃), silicon oxide (SiO₂), titanium oxide (TiO₂) or calcium oxide (CaO). The green sheets 30a and 30b have through holes in which through vias 22a are formed by burying the through holes with a metal such as Ag, Au or Cu. Interconnection patterns made of a metal such as Ag, Au or Cu are formed on surfaces of the green sheets before stacking, and are sandwiched between the adjacent green sheets so that the interlayer interconnections 22b are formed. The through vias 22a and the interlayer interconnections 22b form the internal interconnections 22, which may electrically connect the exposed surface of the uppermost green sheet 30a and the exposed surface of the lowermost green sheet 30c.

Referring to FIG. 3B, the conductive patterns 24 electrically connected to the internal interconnections 22 are formed, by printing, on the lower surface (first main surface) of the multilayer green sheet composed of the green sheets 30a through 30c. The conductive patterns 24 may be made of a conductor that contains a major component of, for example, Ag, Cu or Ni.

Referring to FIG. 3C, an additional green sheet 30d (second green sheet) is stacked to or superimposed on the lower surface of the multilayer green sheet. The additional green sheet 30d has openings 32 located in areas corresponding to the conductive patterns 24. Thus, the conductive patterns 24 are exposed through the openings of the additional green sheet 30d. The conductive patterns 24 may be exposed so that external connections can be made without any trouble. The openings 32 may have shapes identical to or different from those of the conductive patterns 24. The openings 32 may be smaller than the conductive patterns 24 in viewing the multilayer green sheet from the bottom side thereof.

Referring to FIG. 3D, the multilayer green sheet including the additional green sheet 30d, which is now assigned a reference numeral of 30, is vertically pressurized from both sides of the multilayer green sheet 30 with hydraulic pressure or the like. Thus, parts of the conductive patterns 24 are extruded outwards in the openings 32 of the additional green sheet 30d. At this time, it is preferable that the surfaces of the conductive patterns 24 are flush with the surface of the additional green sheet 30d or are lower than the surface of the additional green sheet 30d in the openings 32. This is achieved by, for example, adjusting the thickness of the additional green sheet 30d or the shapes of the openings 32 on the basis of the quantity of the conductive patterns 24 (thickness and volume). For example, when the conductive patterns 24 are about 20 μm thick, the additional green sheet 30d having a thickness of about 25 μm may be used.

Referring to FIG. 3E, the multilayer green sheet 30 is burned together with the conductive patterns 24 after the pressurizing process. This results in a multilayer ceramic substrate 40 having the conductive patterns 24 formed on the lower surface of the multilayer ceramic substrate 40. The openings 32 of the additional green sheet 30d illustrated in FIG. 3D are dents 42 of the multilayer ceramic substrate 40. The burning process contracts the conductive patterns 24 and the multilayer green sheet 30 at given ratios. It is thus preferable that the openings of the additional green sheet 30d are shaped by considering the contraction and the shapes of the dents 42 after the burning.

Referring to FIG. 3F, the protection film 26 is formed on the surfaces of the conductive patterns 24 exposed from the openings 32. The protection film 26 prevents migration of the conductive patterns 24. The protection film 26 may be a laminate of Ni/Pd/Au or Ni/Au in which the lowermost layer is Ni, or may be a single layer of Cu. Preferably, the surface of the protection film 26 is flush with the surface of the lowermost ceramic substrate 40d in order to level the lower surface of the multilayer ceramic substrate 40 on which the protection film 26 is formed. Even if the surface of the protection film 26 is not flush with the surface of the lowermost ceramic substrate 40d, it is preferable that the roughness on the lower surface of the multilayer ceramic substrate 40 is within 5 μm or less. In order to meet the above conditions, it is preferable to adjust the quantity of the conductive patterns 24, the thickness of the additional green sheet 30d or the shapes of the openings 32 and to adjust the thickness of the protection film 26 on the basis of the roughness defined by the surfaces of the conductive patterns 24 and the surface of the lowermost ceramic substrate 40d.

The protection film 26 is formed on the surfaces of the through vias 22a exposed to the upper surface of the multilayer ceramic substrate 40. The above-described steps may be carried out in the form of a wafer. Now, the wafer used to manufacture the electronic device in accordance with the first embodiment is substantially completed.

A process for forming an IPD on the surface of the wafer thus produced will now be described.

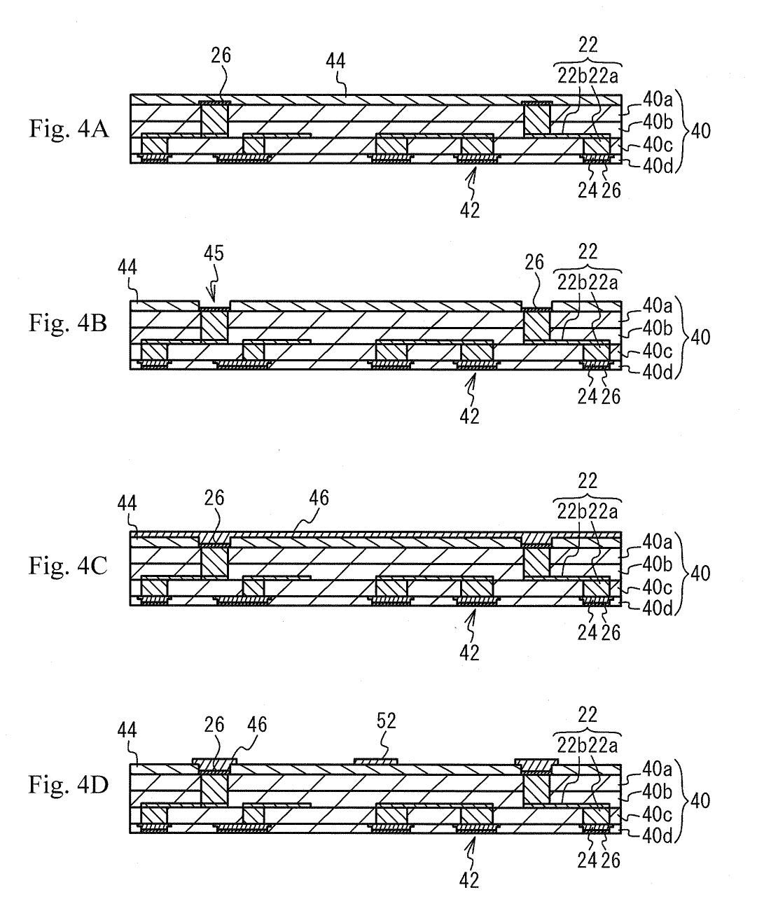

Referring to FIG. 4A, the upper surface of the multilayer ceramic substrate 40 is spin-coated with photosensitive SOG (Spin On Glass) to thus form an insulation film 44. The photosensitive SOG may, for example, be XC800 placed in the market by Sliecs. Sin-coating is repeatedly carried out multiple times to obtain a desired thickness of SOG. The SOG may be annealed at a temperature of 120° C. Referring to FIG. 4B, the wafer is exposed and developed to form openings 45 in the insulation film 44 so as to be located on the through vias 22a. Then, the wafer is cured at 250° C. Thus, the SOG oxide film is formed as the insulation film 44.

A metal layer 46 is formed on the insulation film 44. The metal layer 46 may be a multilayer of Ti/Au/Ti (20 nm/1000 nm/20 nm) on the insulation film 44. The Au film may be replaced with a Cu film. The metal layer 46 may be configured to have a multilayer of Ti/Cu/Ti/Au (20 nm/800 nm/200 nm/20 nm) in which the Ti film is formed on the insulation film 44. In view of reduction of the electrical resistance, the metal layer 46 has the Al, Au or Cu film as a main film. Referring to FIG. 4D, predetermined areas of the metal layer 46 are removed by, for example, ion milling. Thus, the lower electrodes of capacitors are derived from the metal layer 46.

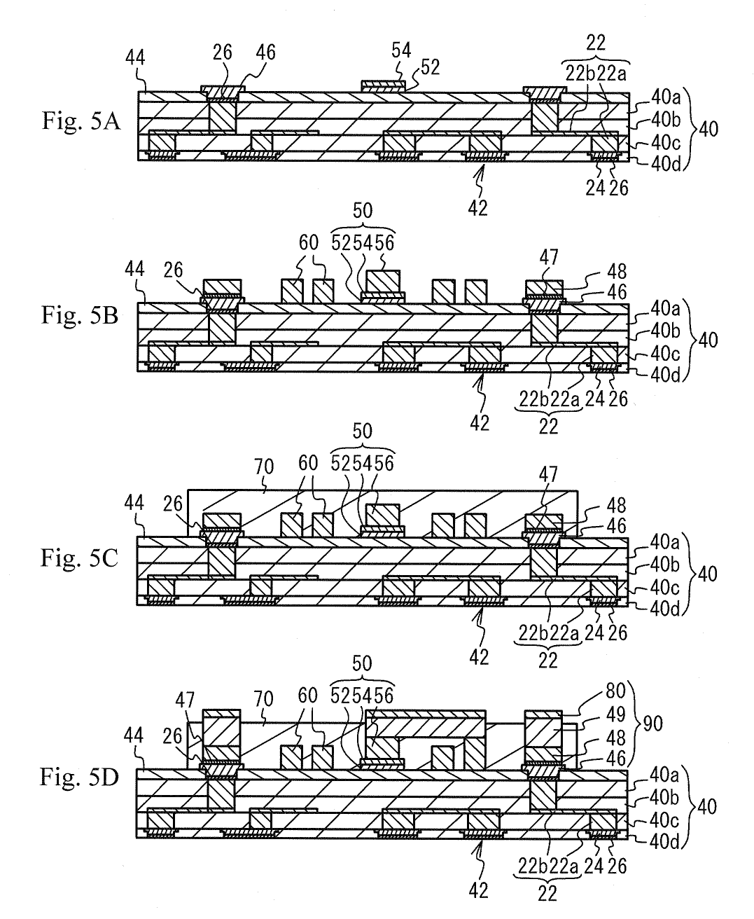

Referring to FIG. 5A, a dielectric film 54 is formed on a lower electrode 52. The dielectric film 54 may be formed by, for example, sputtering or PECVD (Plasma Enhanced Chemical Vapor Deposition), and may be any of SiO₂, Si₃N₄, Al₂O₃ or Ta₂O₃. The dielectric film may be 50 to 1000 nm thick.

Referring to FIG. 5B, a seed layer 47 is formed on the insulation film 44 and the metal layer 46. The seed layer 47 is composed of a Cr film and an Au film. For example, the Cr film may be 20 nm thick, and the Au film may be 500 nm thick. A plating layer 48 is formed on predetermined areas of the seed layer 47 by electrolytic plating. For example, the plating layer 48 may be 10 μm thick and made of Cu. The seed layer 47 is removed by ion milling with the plating layer 48 being used as a mask. Thus, the upper electrodes 56 are formed from the plating layer 48. A capacitor 50 is formed by the lower electrode 52, the dielectric film 54 and the upper electrode 56. A coil of an inductor 60 is formed by the plating layer 48. Further, a lower layer of a connection terminal is formed by the plating layer 48. The seed layer 47 is not illustrated in the capacitor 50 and the inductor 60.

Referring to FIG. 5C, a low-dielectric film 70 is formed on the multilayer ceramic substrate 40 so as to cover the plating layer 48. The low-dielectric film 70 may be PBP (polybenzoxazole), BCB (benzocyclobutene) or the like.

Referring to FIG. 5D, predetermined portions of the low-dielectric film 70 are removed to thus expose the upper surface of the plating layer 48 on which an upper plating layer should be formed. A plating layer 49 is formed by electrolytic plating so as to contact the plating layer 48. For example, the plating layer 49 is 10 μm thick and made of Cu. The plating layer 49 is formed by using a seed layer similar to the aforementioned seed layer 47. A pad layer 80, which may be composed of an Au film and a Ni film, is formed on the plating layer 49. Accordingly, first connection terminals 90, each of which is composed of the metal layer 46 and the plating layers 48 and 49, are formed on the through vias 22a. Now, the IPD using the multilayer ceramic substrate 40 is substantially completed.

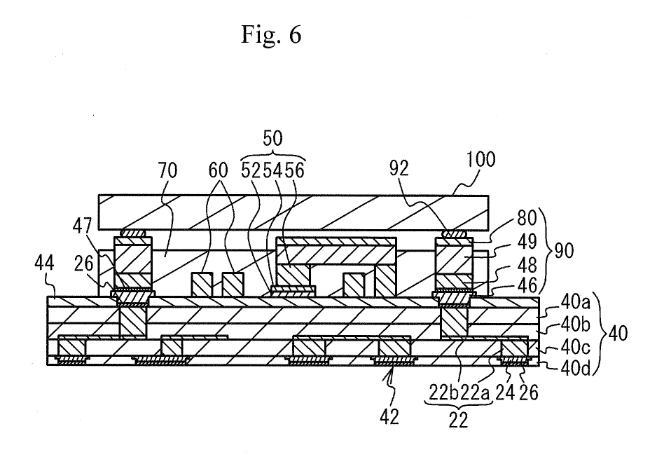

FIG. 6 is a view of a chip (functional element) on the IPD. Bumps 92 made of a metal such as solder or Au are formed on the connection terminals 90. A chip 100 is flip-chip mounted on the connection terminals 90 using the bumps 92. The chip 100 may have a SAW (surface acoustic wave) filter or an electronic element such as an IC. The passive element and the functional element are mounted on the multilayer ceramic substrate 40 through the above-described manufacturing process. The wafer is divided into individual parts, which are electronic devices in accordance with the first embodiment.

In the wafer and the electronic device in accordance with the first embodiment, the lower surface (first main surface) of the multilayer ceramic substrate 40 has the dents 42 which are shaped so as to correspond to the interconnection patterns. The conductive patterns 24 electrically connected to the internal interconnections 22 are provided on the bottom surfaces of the dents 42. It is thus possible to restrain the conductive patterns 24 from greatly protruding from the surface of the multilayer ceramic substrate 40 and secure the flatness of the lower surface of the multilayer ceramic substrate 40.

It is preferable to quickly cool the multilayer ceramic substrate 40 in the step of removing the seed layer 47 by ion milling described with reference to FIG. 5B. The flatness of the lower surface of the multilayer ceramic substrate 40 is kept well, and heat is effectively and efficiently radiated from the lower surface of the multilayer ceramic substrate 40. Thus, the seed layer 47 may be removed efficiently.

The multilayer ceramic substrate 40 is heated and cooled in the process for mounting the electronic element on the upper surface (second main surface) of the multilayer ceramic substrate 40. Since the lower surface of the multilayer ceramic substrate 40 is flattened well, the multilayer ceramic substrate 40 may be heated and cooled efficiently. The good flatness of the lower surface of the multilayer ceramic substrate 40 makes it possible to stably hold the substrate 40 by the wafer chuck in the resist exposure.

There is a method for forming conductive patterns on the surface of the already burned ceramic substrate by sputtering. However, this method does not realize good adhesiveness of the conductive patterns. In contrast, the first embodiment burns the conductive patterns 24 together with the multilayer green sheet 30. Thus, the high adhesiveness to the multilayer ceramic substrate 40 can be realized.

Preferably, the surface of the protection film 26 is flush with the surface of the lowermost ceramic layer 40d. Even if the surface of the protection film 26 is not flush with the surface of the lowermost ceramic layer 40d, the roughness on the surface is preferably 5 μm or less. Thus, the stability and efficiency of thermal conduction can be improved further. In order to meet the above conditions, the surfaces of the conductive patterns 24 are flush with or lower than the surface of the additional green sheet 30d in the openings 32 in the process of pressurizing the multilayer green sheet 30 in FIG. 3C.

The step of forming the protection film 26 may be omitted. In order to prevent the migration of the conductive patterns 24, the protection film 26 is preferably employed.

In the above description of the first embodiment, the passive elements (capacitor 50 and the inductor 60) are directly formed on the surface of the multilayer ceramic substrate 40 by forming the metal layers by the thin-film forming technique. It is possible to employ another process of mounting a completed or discrete passive element and a completed or discrete functional element on the surface of the multilayer ceramic substrate 40. The use of the multilayer ceramic substrate 40 realizes good thermal conductivity in a mounting step such as soldering.

### Second Embodiment

A second embodiment is an exemplary structure in which a cavity for mounting an electronic device is formed in a surface of the multilayer ceramic substrate on which a conductive pattern is formed.

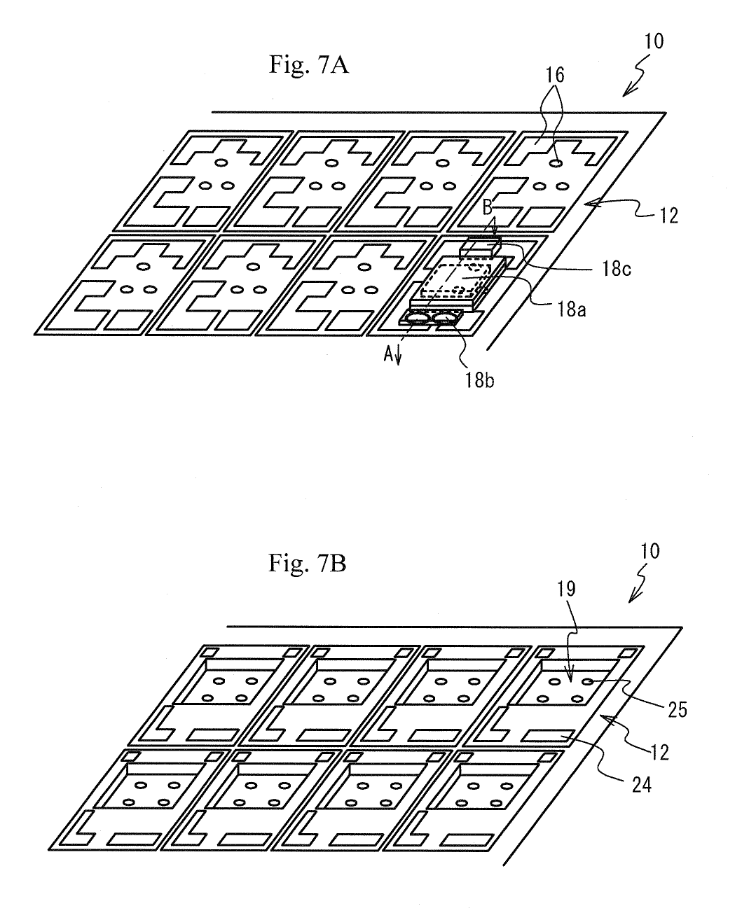

FIG. 7A is a perspective view of a wafer used to manufacture electronic devices in accordance with the second embodiment, and corresponds to an enlarged view of a part of the wafer illustrated in FIG. 1. The surface of the dielectric wafer 10 is segmented into the multiple parts forming sections 12, and surface interconnection patterns 16 electrically connected to the internal interconnections are provided on the surface of each of the parts forming sections 12. The surface interconnection patterns 16 may have a major component of a metal such as Ag, Cu or Ni like the conductive patterns 24 employed in the first embodiment.

Electronic parts 18a through 18c may be provided in the parts forming sections 12. These parts are illustrated in only one parts forming section 12, and those for the other parts forming sections 12 are not illustrated for the sake of simplicity. The electronic parts 18a through 18c may be passive elements such as inductors and capacitors and functional elements such as IC chips and SAW devices. These parts may be completed parts, which may be flip-chip mounted on the dielectric wafer 10, or may be formed on the dielectric wafer 10 by using the thin-film forming technique.

FIG. 7B is a perspective view seen from the backside of the dielectric wafer 10 illustrated in FIG. 7A. The back surface of the dielectric wafer 10 has cavities 19 for mounting the electronic elements in each of the parts forming section 12. Backside interconnection patterns 24 are formed in areas in which the cavities 19 are note formed. The backside interconnection patterns 24 correspond to the conductive patterns 24 used in the first embodiment, and are electrically connected to the internal interconnections not illustrated. Hereinafter, these interconnection patterns 24 and the conductive patterns 24 are simply referred to as conductive patterns 24. Other interconnection patterns different from the conductive patterns 24 are provided on the bottoms of the cavities 19. The other interconnection patterns will be referred to as bottom patterns 25. The bottom patterns 25 are electrically connected to the internal interconnections not illustrated, and are electrically connected to an electronic element mounted in the cavities 19.

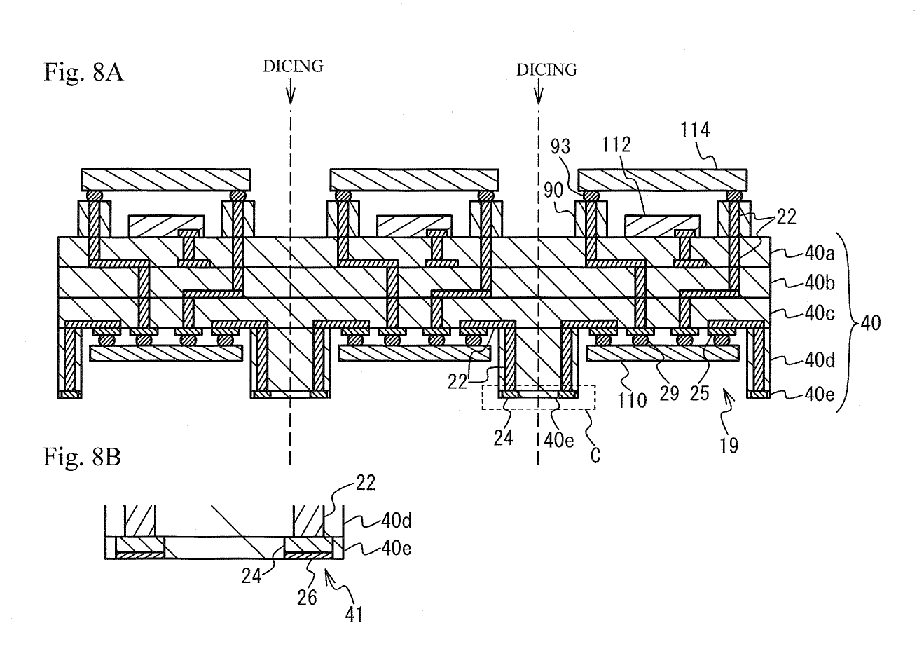

FIG. 8A is a cross-sectional view of the electronic devices in the form of a wafer in accordance with the second embodiment, in which the view is taken along a line A-B illustrated in FIG. 7A. The cavities 19 are formed in the lower surface of the multilayer ceramic substrate 40 in which ceramic substrates 40a through 40e are stacked in the vertical direction. The cavities 19 have the bottom surfaces defined by the lower surface of the ceramic substrate 40c and side walls defined by the ceramic substrate 40d and 40e. The internal interconnections 22 are formed within the multilayer ceramic substrate 40, and the upper and lower surfaces of the multilayer ceramic substrate 40 are electrically connected by the internal interconnections 22.

In the lower surface (first main surface) of the multilayer ceramic substrate 40, conductive patterns (bottom patterns 25) electrically connected to the internal interconnections 22 are formed on the bottoms of the cavities 19. Electronic elements 110 such as IC chips are mounted on the bottom patterns 25 via solder balls 29.

FIG. 8B is an enlarged view of an area C illustrated in FIG. 8A. The side walls of the cavity 19 is defined by the ceramic substrates 40d and 40e. Conductive patterns 24 connected to the internal interconnections 22 are formed on the surface of the ceramic substrate 40d, and protection films 26 used to prevent the migration are provided on the surfaces of the conductive patterns 24. The ceramic substrate 40e has a thickness approximately equal to the total thickness of the conductive patterns 24 and the protection film 26. The ceramic substrate 40e has openings 41 in areas in which the conductive patterns 24 and the protection films 26 are located. That is, the whole multilayer ceramic substrate 40 has dents that are defined by the openings 41 formed in the lowermost ceramic substrate 40e and are located in areas corresponding to the conductive patterns 24.

Turning back to FIG. 8A, passive elements 112 are mounted on the upper surface of the multilayer ceramic substrate 40. Functional elements 114 are connected to the connection terminals 90 via solder bumps 93. The passive elements 112 and the functional elements 114 are electrically connected to the internal interconnections 22. As has been described in connection with the first embodiment, various electronic elements such as inductors, capacitors, IC chips and SAW filters may be mounted on the upper surface of the multilayer ceramic substrate 40 in accordance with a desired function. These electronic devices may be formed directly on the surface of the multilayer ceramic substrate 40 or completed electronic devices may be mounted using solder bumps or the like.

In the method of manufacturing the electronic device in accordance with the second embodiment, green sheets from which the ceramic substrates 40a through 40e are defined are stacked, and are burned together with the conductive patterns 24. Thus, the multilayer ceramic substrate 40 with the cavities 19 is produced. Then, the protection films 26 are formed and the electronic elements 110, the passive elements 112 and the functional elements 114 are formed or mounted. Finally, the multilayer ceramic substrate 40 thus manufactured are divided into individual chips by dicing, so that electronic devices can be obtained.

The electronic devices of the second embodiment have the cavities 19 provided in the areas in which the conductive patterns 24 are not printed. The electronic elements 110 are mounted in the cavities 19, so that the electronic devices can be downsized and height-reduced. When the lower surface of the multilayer ceramic substrate 40 is placed on a heating stage, the cavities 19 do not contact the heating stage. Thus, there is a difficulty in thermal conduction from the heating stage to the cavities 19. In addition, the side walls of the cavities 19 support the total mass, and the stability in support may be degraded.

With the above in mind, as illustrated in FIG. 8b, the conductive patterns 24 and the protection films 26 formed on the lower surface of the multilayer ceramic substrate 40 are arranged so as to bury the dents (openings 41 in the ceramic substrate 40e) formed on the lower surface of the multilayer ceramic substrate 40. This structure improves the flatness of the lower surface of the multilayer ceramic substrate 40. The improved flatness contributes improvements in the thermal conductivity and stability and improves the production yield. The structure in which the conductive patterns 24 are embedded in the dents in the multilayer ceramic substrate 40 is particularly effective to an arrangement the cavities 19 are formed on the same surface on which the conductive patterns are formed as in the case of the second embodiment.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various change, substitutions, and alterations could be made hereto without departing from the spirit and scope of the invention.

What is claimed is:

1. A method of manufacturing an electronic device, the method comprising:
printing a conductive pattern on a first surface of a first green sheet having a multilayer structure, the conductive pattern being electrically connected to an internal interconnection formed in the first green sheet;
superposing a second green sheet on the first surface of the first green sheet, the second green sheet having an opening located in an area corresponding to the conductive pattern;
pressurizing the first green sheet and the second green sheet superposed thereon in directions in which the second green sheet is superposed on the first green sheet;
burning the first green sheet and the second green sheet superimposed thereon to thus form a multilayer ceramic substrate; and
mounting an electronic element on a second surface of the multilayer ceramic substrate opposite to the first surface, the electronic element being electrically connected to the internal interconnection.

2. The method according to claim 1, wherein the pressurizing pressurizes the first and second green sheets so that a surface of the conductive pattern is flush with or lower than a surface of the second green sheet in the opening.

3. The method according to claim 1, further comprising forming a protection film on the conductive pattern after the burning.

4. The method according to claim 1, wherein the mounting the electronic element includes forming a metal layer on the second surface of the multilayer ceramic substrate.

5. The method according to claim 1, further comprising:
forming a cavity in a part of the first surface in which the conductive pattern is not formed; and
forming another conductive pattern on a bottom of the cavity so as to be electrically connected to the internal interconnection within the first green sheet.

6. The method according to claim 5, further comprising another electronic element on the bottom of the cavity so as to be electrically connected to the internal interconnection.

7. The method according to claim 1, wherein the conductive pattern includes a major component of one of Ag, Cu and Ni.

8. The method according to claim 1, further comprising dividing the multilayer ceramic substrate into parts.

9. A wafer comprising:
a multilayer ceramic substrate having an internal interconnection and a surface on which a dent is formed; and
a conductive pattern that is formed on a bottom of the dent and is electrically connected to the internal interconnection, the conductive pattern being a pattern burned together with the multilayer ceramic substrate.

10. An electronic device comprising:
a multilayer ceramic substrate having an internal interconnection and a first surface on which a dent is formed;
a conducive pattern that is formed on a bottom of the dent and is electrically connected to the internal interconnection, the conductive pattern being a pattern burned together with the multilayer ceramic substrate; and
an electronic element that is provided on a second surface of the multilayer ceramic substrate opposite to the first surface and is electrically connected to the internal interconnection.
